(19) United States
(12) Patent Application Publication
(10) Pub. No.: US 2020/0327608 A1
(43) Pub. Date: Oct. 15, 2020

(54) Proximity Based Engagement Apparatus, System, and Method

(71) Applicants: Jern Ern Chuah, Kuala Lumpur (MY); Adam L.K. Philipp, Mercer Island, WA (US)

(72) Inventors: Jern Ern Chuah, Kuala Lumpur (MY); Adam L.K. Philipp, Mercer Island, WA (US)

(21) Appl. No.: 16/546,118

(22) Filed: Aug. 20, 2019

Related U.S. Application Data
(60) Provisional application No. 62/831,710, filed on Apr. 9, 2019.
(60) Provisional application No. 62/872,581, filed on Jul. 10, 2019.

(51) Int. Cl. G06Q 40/02; G06Q 50/00

(52) U.S. Cl. CPC G06Q 40/025; G06Q 50/01

(57) ABSTRACT

Methods, apparatus, and system to create an entity proximity data structure and to assess an engagement with an entity in the entity proximity data structure based on a proximity metric of a first entity relative to a second entity in the entity proximity data structure.

### CROSS-REFERENCE TO RELATED APPLICATIONS

This application is a non-provisional of, incorporates the subject matter of, and claims the benefit of U.S. provisional patent application 62/831,710 filed Apr. 9, 2019 and U.S. provisional patent application 62/872,581 filed Jul. 10, 2019.

### FIELD

The present disclosure relates to at least one of an apparatus, system, or method of proximity based engagement assessment, including a proximity metric derived from an entity proximity data structure comprising interaction vectors.

### BACKGROUND

Obligations include loans. Collection of loans involves payment by a debtor to a creditor or to a delegee or other successor of the creditor (hereinafter, a “delegee”). When a loan is not paid on time, the creditor may identify the unpaid loan as a “non-performing loan” (“NPL”) and sell the debt to a debt collector, who may assume the rights of the creditor with respect to enforcing the NPL. The debt collector may contact the debtor repeatedly, leading some jurisdictions to pass laws to control behavior of debt collectors. Debtors often feel overwhelmed, ashamed, deceived by details in loan documents, isolated, and may have few ways to contact the creditor.

Creditors may bundle NPLs into securities and other financial instruments (NPL bundles) and sell the NPL bundles to parties who attempt to obtain payment of principal and interest, such as through engagement of debt collectors. Often, NPL bundles are sold for less than an amount of unpaid principal and interest of loans, which is called a “discount”. Debt collectors may negotiate installment payments, may seek to garnish wages (if allowed by local law), and seek to enter into settlements with debtors for less than the amount of unpaid principal and interest but more than the discounted amount.

Utilization of credit and NPLs can be an indicator of economic health for a jurisdiction, a financial sector, an industry, an organization within an industry, a family, or an individual. Different jurisdictions have different information collection and reporting systems in relation to utilization of credit and NPLs, with NPLs often being underreported or reported inconsistently. Debtors may not be properly characterized with respect to credit history, credit risk, and regarding whether they are collaborative or non-collaborative. These differences and missing information create uncertainty regarding whether credit is over- or underextended with respect to the jurisdiction, financial sector, industry, organization, family, or individual.

In addition, lengthy debt recovery processes, low opportunity cost induced by accounting rules, tax, and coordination issues lead to first mover disadvantage and can cause capital constraints. A tendency of creditors to wait for periods of economic growth before beginning more aggressive collection of NPSs can exacerbate solvency and liquidity problems for creditors and diminish the economic resilience of financial systems. However, fire-sales of NPLs with too steep of a discount can cause a downward spiral of NPL prices, which causes a contraction in extension of credit to creditors.

In addition, losses with respect to NPLs should be borne by creditors to avoid moral hazard, rather than transferred to jurisdictions or other stakeholders.

In addition, handling of loans, NPLs, debt collection and transfer of money (including cryptocurrencies) should comply with law.

Improved evaluation regarding whether to engage with a party in the form of a loans, increased visibility with respect to credit utilization and NPLs, and improved consistency in reporting would improve macroeconomic performance.

### BRIEF DESCRIPTION OF THE DRAWINGS

FIG. 1 is a network and device diagram illustrating an example of an engagement management computer device, an engagement management computer device datastore, debt assistant group, social network group, open creditor group, entities, a creditor, a plurality of blockchain computer systems, a plurality of social network services, and a network incorporated with teachings of the present disclosure, according to some embodiments.

FIG. 2 is a functional block diagram illustrating an example of an engagement management computer device incorporated with teachings of the present disclosure, according to some embodiments.

FIG. 3 is a functional block diagram illustrating an example of an engagement management computer device datastore incorporated with teachings of the present disclosure, consistent with embodiments of the present disclosure.

FIG. 4 is a flow diagram illustrating an example of a method performed by an entity proximity data structure management module, according to some embodiments.

FIG. 5 is a flow diagram illustrating an example of a method performed by an entity proximity processing module, according to some embodiments.

FIG. 6 is a flow diagram illustrating an example of a method performed by a loan enrollment module, according to some embodiments.

FIG. 7 is a flow diagram illustrating an example of a method performed by a loan execution module, according to some embodiments.

FIG. 8 is a flow diagram illustrating an example of a method performed by a debt assistant module, according to some embodiments.

FIG. 9 is a flow diagram illustrating an example of a method performed by a debt collector module, according to some embodiments.

FIG. 10 is a flow diagram illustrating an example of a method performed by a point management module, according to some embodiments.

### DETAILED DESCRIPTION

Although the following Detailed Description will proceed with reference being made to illustrative embodiments, many alternatives, modifications, and variations thereof will be apparent to those skilled in the art.

In addition to other locations, defined terms may be found at the end of this Detailed Description.

In overview, this disclosure relates to an apparatus, system, and methods (references herein to “the system” or “the engagement management computer system or apparatus” shall be understood all apparatuses, systems, and methods disclosed herein and components thereof, not exclusively to a unitary system) to determine whether and how to engage with a party, such as whether and under what terms a first party may extend credit to a second party, such as in a loan. This determination is made with information from an entity proximity data structure. The entity proximity data structure may be instantiated with interaction vectors between entities. An interaction vector between two entities may comprise a type of relationship between the entities, such as a work relationship, a social relationship, or a familial relationship (as may exist between parties related through genetic relationship or marriage). The interaction vectors may further comprise engagement instances between the entities. Engagement instances may comprise, for example, a verbal or written communication, a presence at a common physical location, a membership in an organization, a promise to act, or an action to fulfill the promise to act. Engagement instances may be positive, negative, or neutral and may have a magnitude. Data of or with respect to engagement instances may be derived via natural language processing (“NPL”) from at least one of a social network service, a telecommunications service, a lending service, or location data.

Total proximity metrics and local proximity metrics may be derived for each entity from an entity proximity data structure. A proximity metric may be a scalar product of interaction vectors. The total proximity metric for an entity may be the scalar product of all interaction vectors between such entity and all associated entities of such entity; the local proximity metric may be a scalar product of interaction vectors between such entity and a subset of all associated entities of the entity, such as between the entity and one other entity or a type or category of entity, such as creditors or members of a debt assistant group which comprises the entity.

The engagement management computer apparatus or system may include one or more computer devices. The computer devices may include or be provided by discrete computers (including discrete computer instances executed “virtually” in a remote computer center) as well as distributed computer systems, such as blockchain computer systems.

As used herein, an “entity” may be one or more of the apparatus or system for proximity engagement assessment, an organization, or an individual. For example, an entity may be a debtor, a creditor, a debt assistant, a debt collector, a payor, or another organization or individual who may be registered with or monitored by the system.

The engagement management computer system may allow entities to register pre-existing and new loans in the system. Loans registered or enrolled in the system are referred to herein as “loans”. Anonymized or other information regarding loans registered in the system may be made available to users of the system and/or the public, such that users of the system or the public will see information regarding credit utilization, including NPL. When registered in the system, loans or information regarding loans may be published to one or more blockchain computer systems. Loans or information regarding loans may be published to blockchain computer systems as records and/or as smart contracts, including as smart contracts in which payments may be made through or via a blockchain computer system. Other loans registered with the system may be executed or performed not on or by a blockchain computer system, but may nonetheless be monitored, reported on, and acted with respect to by the system.

Incentives may be offered to register and/or create loans in the engagement management computer system, to engage in a debt assistant group, to engage as a debt collector, or to otherwise engage with the engagement management computer system.

Such incentives may include points which may be redeemed for cash, forgiveness of debt, and for goods and services, including goods and services offered by sponsors in the system.

Such incentives may include establishment of and/or increase of a “pip” rating of an entity, wherein the pip rating may correspond to an interest rate earned or eligible to be earned from loans in the system.

Such incentives may include facilitation by the engagement management computer system of collection activities by debt collectors.

Such incentives may include action by debt assistants in debt assistant groups to keep one another current with respect to a loan registered with or created in the system.

Such incentives may include increased visibility with respect to utilization of credit in a political jurisdiction, a geographic region, an economic sector, an industry, a family group, or the like.

Such incentives may include access to financial information of entities, for example, to determine whether an entity has assets to support a request by the entity for a loan.

Such incentives may include non-publication of information regarding an entity, including non-publication with respect to a subset of an otherwise allowed group of viewers of such information and/or including anonymization of information which may be published.

Debt assistants and debt assistant groups.

The system may facilitate formation of debt assistant groups. Debt assistant groups may comprise debt assistants, including debt assistants who are associated through one or more social network services. The system may suggest debt assistants from “friends”, “connections” or otherwise in social network services, such as social network service-1 120 or social network service-2 121, or from entities in the system. Debt assistants and prospective debt assistants may also recommend or refer others to become debt assistants. Debt assistants do not have to be members of a social network service, though it may be preferred.

Debt assistants may be entities who or which help one another with spending and management and settle debts, including debts memorialized in loans, including loans within a debt assistant group and external loans of a member of a debt assistant group. The system may gather information regarding and debt assistants may be provided with a view of their own spending histories, income, and budgetary goals as well as with a view of spending histories and budgetary goals of members of a debt assistant group(s). Debt assistants may also be provided with a view of debts and loans of members of their debt assistant group. Debt assistants may be provided with a view of current spending by members of the debt assistant group relative to budgetary goals, historical spending, hard obligations to fulfill loan obligations, and income. The amount of information provided with respect to a debt assistant may be variable; incentives, including availability of services or sub-subservices, may be offered to provide more information.

In view of the budgetary and income information provided by the system, debt assistants may enter into loans with one another, to help one another meet loan obligations or otherwise. For example, if a first debt assistant in a debt assistant group is exceeding a budget with respect to meals, and a second debt assistant in the debt assistant group is under budget with respect to meals or another area, then the second debt assistant may enter into a loan with the first debt assistant so that the first debt assistant can meet the first debt assistant's obligations. Debt assistants may earn points for making such loans as well as points for paying off such loans. Engagement instances which occur with respect to such loans may be tracked, effecting total proximity metrics and local proximity metrics for entities involved (as discussed further herein). These loans may be registered with and/or created in the system. These loans may be microloans. Terms of these loans may be based at least in part on total proximity metric and/or local proximity metrics of the parties to such loan, as well as, for example, an entity's credit score, pip rank and/or points in the system. The terms of such a loan may be more favorable to a debtor when the debtor has a higher total proximity metric than a creditor to the loan. For example, an interest rate of such loan me be lower when the debtor has a higher total proximity metric than the creditor; if the same debtor gets a loan with the same principal amount and maturity date but with a different creditor who has a higher proximity metric than the debtor, then the interest rate may be higher.

Debt assistants may keep the debtor in check in relation to incurring and paying obligations. Debt assistants may include the debtor's friends or family who will encourage the debtor to keep to a consistent settlement of debt. If a debtor falls behind on payments, debt assistants, if not already active, may be informed and activated or encouraged to contact the debtor. Such contacts may constitute engagement instances between such parties. Such contacts may also earn such parties points in the system. Debt assistants may earn more points, larger proximity metric(s), and the like if they join the system at an earlier time.

As a term of a loan or otherwise, a creditor may require a debtor to sign up to the engagement management system and recommend or have debt assistants in a debt assistant group, which debt assistants may help the debtor stay on time in relation to repayment of the debt, obligation, or loan owed to the creditor. As a term of a loan or as a condition to earning points in the system or as a condition to being credited with positive engagement instances (as opposed to receiving credit for neutral engagement instances in the case of all positive and neutral engagement instances, but while being credited with negative engagement instances), a creditor and/or the engagement management system may require that a debtor be part of a debt assistant group comprising debt assistants. The creditor and/or engagement management system may require a minimum number of debt assistants and/or debt assistants with a local proximity metric above a threshold relative to the debtor. A number of debt assistants with respect to a loan may be determined from at least one of, for example, an amount of principal, a total proximity metric of the debtor, a local proximity metric of the debtor, a ratio of the total proximity metric of the debtor and the total proximity metric of the creditor, a ratio of the local proximity metric of the debtor and a party, such as a debt assistant, a group of debt assistants, creditors in general, or the creditor, or a combination thereof.

In general terms, when credit such as a loan is extended to a debtor in the system, the more consistent over time and the better connected the prospective debt assistants are with the debtor and/or with other people in the entity proximity data structure, e.g. the higher the total proximity metric of the debt assistants, the fewer number of them may be compulsory with respect to a loan.

In addition or alternatively, the better the credit history of the debtor, the fewer compulsory debt assistants may be required. In addition to a number of debt assistants who may be compulsory or required in relation to a loan, debtors can freely provide more names to the system of parties who may be entities, including debt assistants.

Information regarding debt assistants and other entities may be derived from social network services, from loans and lending services, from creditors, from financial services, from credit history, from telecommunications services, and from location data. Entities may provide their credentials for financial service providers, employers, and the like to the system, to thereby allow the system to access a more complete view of such entities' financial information.

Debt assistants, debt collectors, debtors, creditors and other entities may be invited to join the system and/or may already be in the system—the earlier an entity joins, the bigger a commission may be drawn from collection activities by the entity, the more points (and rewards) on the system such entity may obtain, and the higher an interest rate or pip the entity may earn on loans made in the system. The system may monitor engagement instances on as many social network services and in as many forms of media as it can.

Debtors and other entities may voluntarily disclose or make available more information to the system to earn points, receive rewards, and the like. The information may be used by the system, such as to determine points, pip rating, credit score, loan terms, and the like. Certain of the information may be disclosed by the system to, for example, debt assistants, creditors, and debt collectors. Examples of more information include, for example, credit status, loans of the debtor, account balances at financial institutions, job, salary, tax, budgets, and other financial information, and other information regarding the debtor and others.

Points.

Entities may be rewarded points when they act in the system, engage in an engagement instance with the system and/or relative to a loan, an/or when they communicate with and have an engagement instance with a debtor, and/or another entity. A multiplicity of actions in the system or in other social network services and communication networks monitored by the system can result in the system awarding points to an entity. For example, registering with the system may result in points for the registering party and/or by a referral party. For example, making a loan or making money available to be loaned may result in points for the creditor party. For example, payment toward a loan obligation by a debtor, by a debt assistant, by a debt collector, or by another payor may result in points for such party. For example, communication among members of a debt assistant group may result engagement instances and in points for such communications. For example, communication by a debtor with a creditor and/or with a debt collector may result in engagement instances and/or points for such communications.

Points may be converted into rewards or result in other privileges or demerits. Rewards and demerits may include, for example, cash (cash is understood to include fiat currency issued by a central bank of a government as well as cryptocurrencies, cryptographic tokens, and the like), change (such as reduction or increase) in principal of a loan, change in interest paid on a loan, change in interest paid to a party (or a “PIP Rating” of such party), goods and/or services offered by a sponsor, and the like.

The number of points earned for an action can depend on the status of a debtor relative to a loan and/or relative to debt assistants and debt collectors, as may be measured according to, e.g., a total proximity metric and/or local proximity metric of the debtor and/or the creditor and debt assistants and debt collectors. E.g. if a loan is being paid on time and a debtor has a positive local proximity metric with respect to the creditor and/or debt assistants, points earned in relation to engagement instances by debt assistants with the debtor may be low; if the loan is not being paid or becomes NPL, or if the number of debt assistants or debt collectors falls in relation to the loan or the debtor, or if engagement instances by the debtor fall, and/or the debtor's total proximity metric and/or local proximity metric with respect to the creditor and/or debt assistants fall, points available to be earned in relation to communications relative to the loan or the debtor may be increased.

Debt Collectors.

If a debtor fails to pay and a loan goes into default and then becomes an NPL or if a loan is already an NPL, debt assistants (or any entity registered with the platform) may become debt collectors.

In addition to registering loans in the system in order to provide support to the debtor by debt assistants, banks and other creditors can register NPLs in the system to solicit the services of debt collectors. Debt collectors may “swipe right” (or equivalent) in a “swipe right” board (or equivalent) to accept a collection job relative to an NPL and may, if they do not already have one, be given an identifier (such as a blockchain identifier). They then take on the responsibility of collecting under the loan (with or without the sharing of information by the bank/country). The debt collector may pursue the debtor and/or others who may be willing to be a payor for the debtor and may provide such parties a payment address, account, link, blockchain identifier, or the like which is associated with the debt collector. Payments toward the NPL may be credited or attributed to the debt collector through use of such payment address, account, link, blockchain identifier, or the like. Where allowed, surveillance systems may be used by the system to provide real time information to debt collectors regarding where debtors are, so that debtors have difficulty avoiding contact with debt collectors.

Debt collectors may also sign up to location-based collection. E.g., debt collector-1 is in Starbucks, and is free, so signs on to the system and learns from the system that proximate to debt collector-1 there are four people who are behind on loans, debtors-4, and a fifth debtor, debtor-5. Through, for example, debt collector module 900, debt collector-1 can see that debt collector-1 is connected to debtor-5 through one degree of separation. Debt collector-1 can then take a hard approach with respect to debtors-4 or use a soft approach in relation to debtor-5. Debt collector-1 may “accept” debt collection in relation to debtors-4 or debtor-5, so that if a payment is made which is attributable to debt collector-1, debt collector-1 may receive a commission.

A debt collector may earn a commission, including a variable commission, for loan payments that are attributable to the debt collector. The commission may be reduced, such as toward zero, if the risk of non-recovery of the loan falls, such as if the loan is in or returns to good standing and/or if payments have been made for a sustained period of time and/or if an alternative payor is identified and/or if the debtor is interacting positively with debt assistants or debt collector, such as according to a local proximity metric relative to such parties and/or the debtor's total proximity metric. The commission may be increased if the risk of non-recovery of the loan increases, such as if payments falter or are late, if alternative payors are not or are no longer available, if the number of debt assistants in a debt assistance group of the creditor fall, the debtor's total proximity metric and/or local proximity metric falls or the like.

Banks and other creditors may provide a countdown clock or period on or relative to the collection of NPL, e.g. 12 months, and provide an inversely scaled commission or discount on collection. E.g. the system is given 12 months to collect, and if it does, then the system only returns to the creditor a percentage of the collected amount, such as 90%, but if the loan obligation is collected within 3 months, then a different percentage, such as 80% may be returned to the creditor; within 4 months 82.5%, and so forth. E.g., the quicker the collection the more the system may make by having to return less to the creditor. The system may pay out to debt collectors a fraction of the amount retained by the system, such as a commission, with a similar scaling.

An entity, such as a debt collector, a debt assistant, or another payor, may pay off an NPL completely, in which case such payor may receive back a premium, such as, for example, 20% of the loan principal, 20% of the outstanding balance at the time of payment, or the like.

Loan Administration.

The rules of a loan may be referred to herein as “loan logic”. Administration of loan logic may be through a database and computer system internal to or directly executed by the system or may be through a smart contract and a blockchain computer system, wherein the loan logic is executed by a distributed computer system. Use of a smart contract and a blockchain computer system may provide visibility regarding at least one of a principal amount of a loan, an interest rate of a loan, an amount of a payment toward the loan, an identity of a payor, an identify of a creditor, an identity of a debtor, an amount of a commission, an amount of a discount, an amount paid to a creditor of the loan, an amount paid to the system, algorithms which implement loan logic, and the like. If the blockchain does not natively provide anonymity or privacy, visibility of records on a blockchain computer system may be controlled by encrypting the records and selectively providing or not providing the decryption key(s) regarding such records. Use of a smart contract and a blockchain computer system for loan administration may allow a plurality of parties to enter into and/or access information regarding such loans without having to trust a central authority to administer or provide information with respect to such loans.

Performance or execution of loan logic may be by a private computer system or by one or more smart contracts and through records in a public blockchain.

Loans published to and/or administered through a computer system, whether as records and logic in a private computer system or whether as one or more smart contracts and records in a public blockchain computer system, may be published or otherwise made accessible to be funded with a requested principal amount. The loan logic may require that all of a requested principal amount be provided, including that it be provided within a time period, or that a partial funding of the requested principal amount may be provided. The loan logic may provide that if all or a threshold of requested principal is not provided, or not provided within a time period, that amounts submitted to fund the requested principal amount may be returned or that amounts set aside to fund the requested principal amount may not be drawn upon. Return of funds from a loan may be to an address or account that transmitted such funds.

The loan logic may provide that only certain parties or parties with a status in the system may become creditors of a loan. The status in the system may include, for example, that the creditor be a debt assistant (as may be the case for microloans created in the system between debt assistants), that the creditor be an associated entity with respect to the debtor (e.g. that there be engagement instances between the creditor and debtor), or that that the creditor be a creditor enrolled in the system. The loan logic may provide that a party which transmits funds or cryptocurrency to an account or address of or associated with the principal of the loan (the “loan principal address”, e.g. “loan principal address ”) is a creditor of the loan, wherein the party is identified by, for example, an address or account used to transmit the cryptocurrency or funds to the loan principal address (a “loan funding address”) and/or by an identifier associated with the address or account which transmits the cryptocurrency or funds to the loan principal address. The loan logic may not accept transmission of cryptocurrency or funds to the loan principal address if the transmission is not from or associated with an allowed party. The loan logic may provide that the loan principal address may transmit cryptocurrency or funds to an intended recipient of the loan principal or that the loan principal address and cryptocurrency or funds therein may be accessed by an intended recipient of the loan principal. The loan logic may provide that a portion of the loan principal, such as a percentage or a fixed amount, be transmitted to or may be accessed by a party as a loan origination fee, as a gas fee, or the like.

The loan logic may provide an address or addresses or accounts to which payments toward the principal and Interest are to be made (the “loan payment address”, e.g. “loan payment address 397”). The loan logic may allow any address or account to transmit cryptocurrency or funds to the loan payment address or may allow that only certain parties or parties with a status in the system may transmit cryptocurrency or funds to the loan payment address. The status in the system may include, for example, status as a debtor under the loan, as a debt assistant to the creditor, as a debt collector of the loan, as an associated entity relative to the debtor in the entity proximity data structure, as an entity enrolled in the system, or the like.

The loan logic may provide that a party which transmits cryptocurrency or funds to the loan payment address is or becomes a payor under the loan, wherein the payor under the loan is identified by, for example, an address or account used to transmit the cryptocurrency or funds to the loan payment address and/or by an identifier associated with the address or account which transmits the cryptocurrency or funds to the loan payment address. The loan logic may not accept transmission of cryptocurrency or funds to the loan payment address if the transmission is not from or associated with an allowed party. The loan logic may provide that the loan payment address may transmit cryptocurrency or funds to or may be accessed by a designated recipient of the loan payment, such as the creditor or a delegee of the creditor. The loan logic may provide that a portion of the loan payment, such as a percentage or a fixed amount, be transmitted to or may be accessed by a party as a commission, as a loan management fee, as a gas fee, or the like. The loan logic may provide that payments to the loan payment address be transmitted to or accessed by the designated recipient of the loan payment or that payments to the loan payment address be accumulated for a period of time and/or until a threshold is met before such payments may be transmitted or accessed by a designated recipient of the loan payment.

The loan logic may provide a status indicator with respect to a loan. The status indicator may indicate, for example, that loan payments are or are not current, that progress goals with respect to loan payments are or are not current, that loan payments are in default, that a loan is characterized by a creditor or by past status of loan payments as processed by the loan logic as an NPL, and the like.

Payment toward a loan may be an engagement instance between associated entities.

Loan logic may be executed in computer systems of financial institutions, such as banks, credit card companies, other creditors, or the like, or in computer systems which have access to such records, such that if payments or other status changes occur with respect to loans in the records of such financial institutions or creditors, then corresponding updates may be made to loans as may be administered by the system in computer systems of the system, including in smart contracts and blockchain computer systems which may be used or monitored by the system. For example, if a debtor or another payor toward a loan pays through a bank or creditor directly, this may thereby be logged and credited to the system by information provided by an entity or provided by access to bank accounts of an entity. If a debt collector pays on behalf of a debtor (the debt collector might have collected in cash or debt collector might even pay out of compassion for the debtor) then this may also be logged.

Debt collectors and debt assistants may earn points or commission(s) for collection. Points may be converted into money, goods or services, or used to defray such party's obligations, as rewards for points may allow. An NPL debtor can become a debt collector with respect to others to defray such debtor's debt or limit the amount of information shared about such debtor for a time on the platform, so such debtor may get some respite from other debt collectors.

Information regarding entities may be made available to a subset of the public or to the public. Some such information may be anonymized and/or aggregated. Some such information may include, for example, an entity's name, an entity's cryptographic identifier (which may be a public anonymous identifier), an entity's debts, a rate or incidence of payment by such entity toward obligations owed by the entity or owed by other parties but with respect to which the entity is a payor, an entity's NPL loans, an entity's pip rating, and entity's local proximity metric relative to a group, class, or type of associated entity (such as relative to debt assistants, creditors, and the like) an entity's total proximity metric, and the like. This information may be provided to encourage maintenance of good financial practices by such entity, e.g. “name and shame”, or the reverse, identification of entities with a “hero” status, or to provide information to the public regarding credit utilization and financial health.

Sponsors.

Entities may also be sponsors of rewards. Sponsors may have a variety of motivations, including for example, access to debt assistants to act as debt collectors with respect to NPL loans of a sponsor. If a creditor enrolls loans in the system, they may be required to be a sponsor. Sponsors may sponsor rewards, advertise on or through or with information obtained from the system, or otherwise interact with the system.

Review of Drawing Sheets.

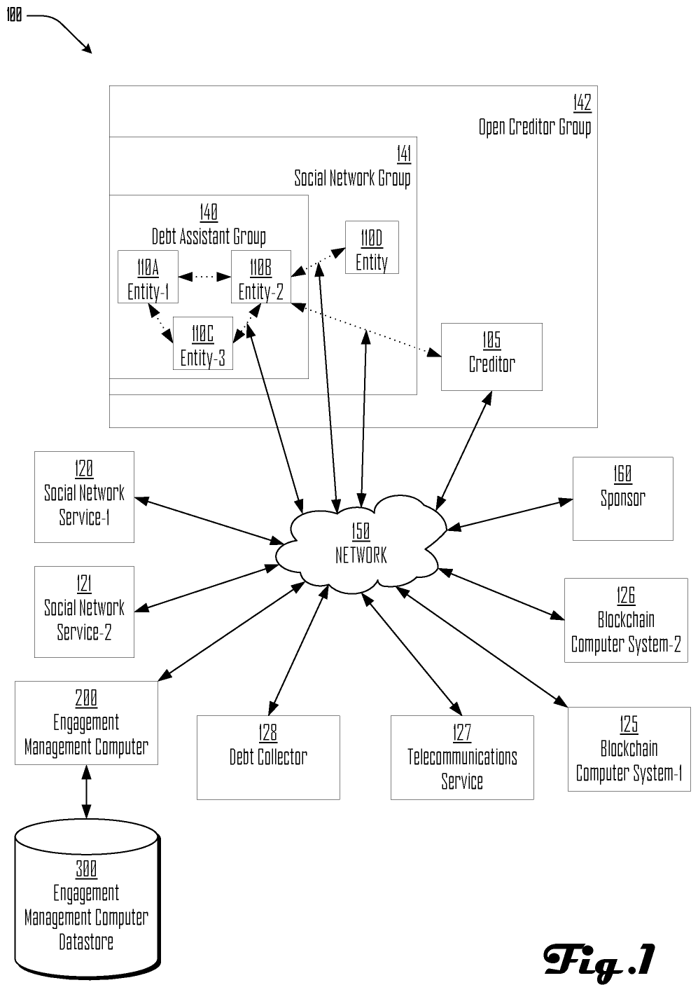

FIG. 1 is a network and device diagram illustrating an example of engagement management computer device 200, engagement management computer device datastore 300, debt assistant group 140, social network group 141, open creditor group 142, entities 110, creditor 105, telecommunications service 127, debt collector 128, examples of blockchain computer systems, such as blockchain computer system-1 125 and blockchain computer system-2 126, sponsor 160, examples of social network services, such as social network service-1 120 and social network service-2 121, and network 150 incorporated with teachings of the present disclosure, according to some embodiments.

As discussed herein, engagement management computer device 200 may perform entity proximity data structure management module 400 and sub-routines or sub-modules thereof, such as entity proximity processing module 500, loan enrollment module 600, loan execution module 700, debt assistant module 800, debt collector module 900, and point management module 1000.

As discussed herein, entity proximity data structure management module 400 may be used to publicize information, including anonymized and aggregated information, regarding status of loans. This information may be relative to a jurisdiction, a region, an industry sector, a family, and/or an individual. Entity proximity data structure management module 400 may sign-in entities to accounts in entity proximity data structure management module 400.

Entity proximity data structure management module 400 may perform entity proximity processing module 500 with respect to entities enrolled with a registered account, for entities who may be enrolled, such as debtors who may be identified to the system by creditors, and generally for entities which entity proximity processing module 500 may find in social network services.

Entity proximity processing module 500 may monitor social network services, such as social network service-1 120 and social network service-2 121, for engagement instances occurring among entities. Engagement instances may comprise communications. Natural language processing algorithms (“NLP”) may be performed on communications. NLP may identify that engagement instances may be positive, negative, or neutral and may have a magnitude. Positive, negative, or neutral values as well as magnitude may be determined by NLP algorithms performed by, for example, hardware acceleration module 210. NLP may be performed locally, relative to each entity or each state representing an entity.

Entity proximity processing module 500 may form an entity proximity data structure, such as entity proximity data structure 310. Entity proximity data structure 310 may comprise entities. Entities with engagement instances between them may be referred to as “associated entities”. Types or classes of relationships among associated entities may be assigned according to, for example, work relationships, social relationships, and familial relationships. Separate entity proximity data structures 310 may be formed for different types or classes of relationships or single entity proximity data structure 310 may be formed with identifiers for the separate types or classes. Entity proximity data structure 310 may further comprise interaction vectors between entities. Interaction vectors may comprise engagement instances. As noted, engagement instances may be positive, negative, or neutral and may have a magnitude. Engagement instances may be communications between entities monitored by entity proximity processing module 500 in, for example, social network services, telecommunications services, and lending services (e.g., as between an entity 110 and creditor 105 or as between entities 110 in debt assistant group 140).

Entity proximity processing module 500 may determine a proximity metric as a scalar product, or a like combination or transformation, of interaction vectors between a first entity and one other or a plurality of associated entities in the entity proximity data structure. When determined relative to all interaction vectors between a first entity and all associated entities of the first entity, the proximity metric may be a total proximity metric, e.g. 312. When determined relative to a subset of all associated entities of the first entity, such as relative to a single second entity or such as relative to associated entities in a debt assistant group 140, the proximity metric may be a local proximity metric, e.g. 311. For example, the proximity metric may range between zero and one, where zero occurs when the first entity has no interaction vectors and no associated entities and where one occurs when all entities in the entity proximity processing module are associated entities of the first entity and the first entity has continuous interaction vectors with all such associated entities. The proximity metric may be determined separately for positive, negative, and neutral engagement instances, such that a separate proximity metric is provided for each. The proximity metric may combine interaction vectors into one proximity metric, such as a scalar product. The proximity metric may be a multi-dimensional string or a representation thereof.

With the entity proximity data structure from entity proximity processing module 500, entity proximity data structure management module 400 may further perform loan enrollment module 600, loan execution module 700, debt assistant module 800, debt collector module 900, and point management module 1000, as discussed herein.

These further modules may, among other services, provide entity proximity data structure management module 400 with information which it publishes. The information published by entity proximity data structure management module 400 may improve dissemination and visibility of loans, credit utilization, and NPL in jurisdiction, regions, sectors, industries, for individuals, thereby improving macroeconomic performance, if not also microeconomic performance.

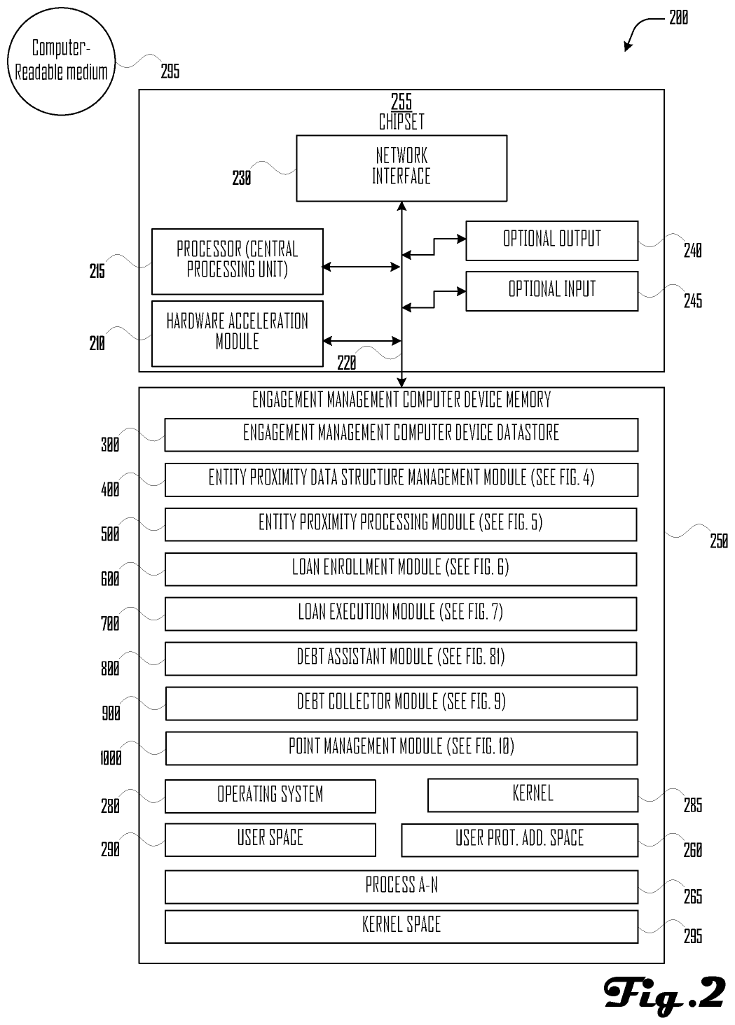

FIG. 2 is a functional block diagram illustrating an example of engagement management computer 200, incorporated with teachings of the present disclosure, according to some embodiments. Engagement management computer 200 may include chipset 255. Chipset 255 may include processor 215, input/output (I/O) port(s) and peripheral devices, such as output 240 and input 245, and network interface 230, and computer device memory 250, all interconnected via bus 220. network interface 230 may be utilized to form connections with network 150, with engagement management computer datastore 300, or to form device-to-device connections with other computers.

Chipset 255 may include communication components and/or paths, e.g., buses 220, that couple processor 215 to peripheral devices, such as, for example, output 240 and input 245, which may be connected via I/O ports. Processor 215 may include one or more execution cores (CPUs). For example, chipset 255 may also include a peripheral controller hub (PCH) (not shown). In another example, chipset 255 may also include a sensors hub (not shown). Input 245 and output 240 may include, for example, user interface device(s) including a display, a touch-screen display, printer, keypad, keyboard, etc., sensor(s) including accelerometer, global positioning system (GPS), gyroscope, etc., communication logic, wired and/or wireless, storage device(s) including hard disk drives, solid-state drives, removable storage media, etc. I/O ports for input 245 and output 240 may be configured to transmit and/or receive commands and/or data according to one or more communications protocols. For example, one or more of the I/O ports may comply and/or be compatible with a universal serial bus (USB) protocol, peripheral component interconnect (PCI) protocol (e.g., PCI express (PCIe)), or the like.

Hardware acceleration module 210 may provide hardware acceleration of various functions otherwise performed by modules discussed herein. Hardware acceleration module may be provided by, for example, Integrated Performance Primitives software library by Intel Corporation, as executed by an Intel (or other compatible) chip, and which may implement, for example, a library of programming functions involved with real time computer vision and NLP. Such a library includes, for example, OpenCV. OpenCV includes, for example, application areas including 2D and 3D feature toolkits, egomotion estimation, facial recognition, gesture recognition, human-computer interaction, mobile robotics, motion understanding, object identification, segmentation and recognition, stereopsis stereo vision (including depth perception from two cameras), structure from motion, motion tracking, and augmented reality. OpenCV also includes a statistical machine learning library including boosting, decision tree learning, gradient boosting trees, expectation-maximization algorithms, k-nearest neighbor algorithm, naïve Bayes classifier, artificial neural networks, random forest, and a support vector machine, which may be used with respect to NLP. In embodiments, hardware acceleration module 210 may be a programmed FPGA, i.e., a FPGA which gate arrays are configured with a bit stream to embody the logic of the hardware accelerated function (equivalent to the logic provided by the executable instructions of a software embodiment of the function). In embodiments, hardware acceleration module 210 may also or alternatively include components of or supporting computer device memory 250.

Computer device memory 250 may generally comprise a random access memory (“RAM”), a read only memory (“ROM”), and a permanent mass storage device, such as a disk drive or SDRAM (synchronous dynamic random-access memory). Computer device memory 250 may store program code for modules and/or software routines, such as, for example, modules discussed herein, hardware acceleration module 210, and engagement management computer datastore 300.

Computer device memory 250 may also store operating system 280. These software components may be loaded from a non-transient computer readable storage medium 295 into computer device memory 250 using a drive mechanism associated with a non-transient computer readable storage medium 295, such as a floppy disc, tape, DVD/CD-ROM drive, memory card, or other like storage medium. In some embodiments, software components may also or instead be loaded via a mechanism other than a drive mechanism and computer readable storage medium 295 (e.g., via network interface 230).

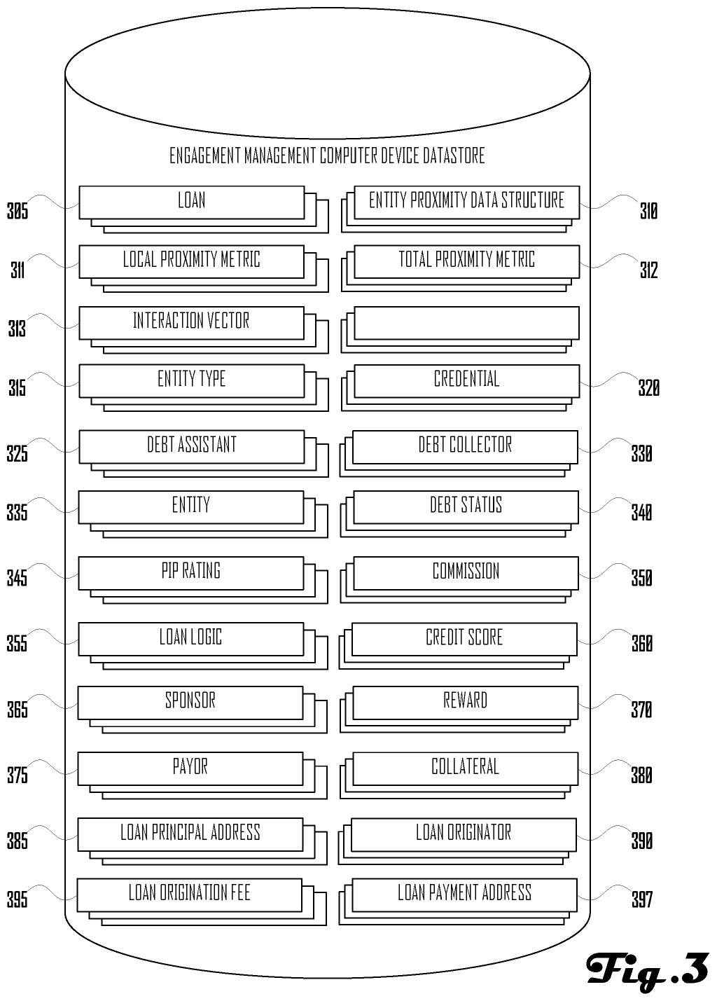

Computer device memory 250 is also illustrated as comprising kernel 285, kernel space 295, user space 290, user protected address space 260, and engagement management computer datastore 300 (illustrated and discussed further in relation to FIG. 3).

Computer device memory 250 may store one or more process 265 (i.e., executing software application(s)). Process 265 may be stored in user space 290. Process 265 may include one or more other process 265a . . . 265n . One or more process 265 may execute generally in parallel, i.e., as a plurality of processes and/or a plurality of threads.

Computer device memory 250 is further illustrated as storing operating system 280 and/or kernel 285. The operating system 280 and/or kernel 285 may be stored in kernel space 295. In some embodiments, operating system 280 may include kernel 285. Operating system 280 and/or kernel 285 may attempt to protect kernel space 295 and prevent access by certain of process 265a . . . 265n.

Kernel 285 may be configured to provide an interface between user processes and circuitry associated with engagement management computer 200. In other words, kernel 285 may be configured to manage access to processor 215, chipset 255, I/O ports and peripheral devices by process 265. Kernel 285 may include one or more drivers configured to manage and/or communicate with elements of engagement management computer 200 (i.e., processor 215, chipset 255, I/O ports and peripheral devices).

Engagement management computer 200 may also comprise or communicate via bus 220 and/or network interface 230 with engagement management computer datastore 300, illustrated and discussed further in relation to FIG. 3. In various embodiments, bus 220 may comprise a high-speed serial bus, and network interface 230 may be coupled to a storage area network (“SAN”), a high speed wired or wireless network, and/or via other suitable communication technology. Engagement management computer 200 may, in some embodiments, include many more components than as illustrated. However, it is not necessary that all components be shown in order to disclose an illustrative embodiment.

FIG. 3 is a functional block diagram of engagement management computer datastore 300 illustrated in the computer device of FIG. 2, according to some embodiments. The components of engagement management computer datastore 300 may include data groups used by modules and/or routines. The data groups used by modules or routines illustrated in FIG. 3 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, references to other database entries, joins, conditional logic, tests, and similar. Records in engagement management computer datastore 300 may comprise, for example, the following: loan 305, entity proximity data structure 310, local proximity metric 311, total proximity metric 312, interaction vector 313, entity type 315, credential 320, debt assistant 325, debt collector 330, entity 335, debt status 340, pip rating 345, commission 350, loan logic 355, credit score 360, sponsor 365, reward 370, payor 375, collateral 380, loan principal address 385, loan originator 390, loan origination fee 395, and loan payment address 397.

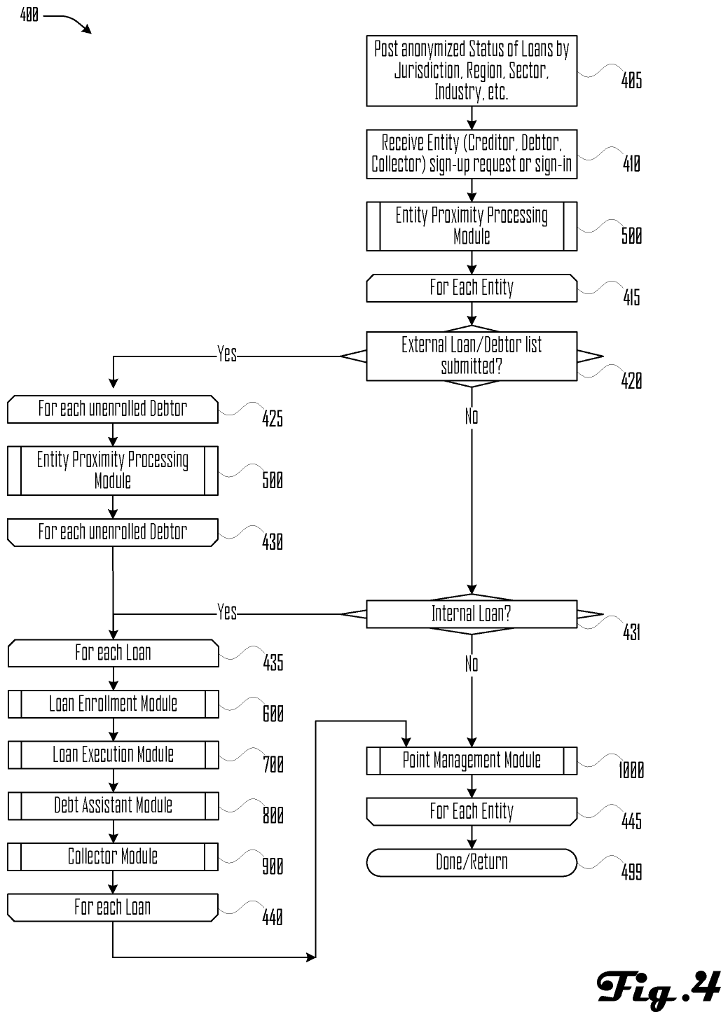

FIG. 4 is a flow diagram illustrating an example of a method performed by an entity proximity data structure management module 400, according to some embodiments. Entity proximity data structure management module 400 may be performed by, for example, engagement management computer 200.

At block 405, entity proximity data structure management module 400 may publicize information regarding entities, entity proximity, proximity metrics, loans, credit utilization, NPL, and the like. The information may be relative to a jurisdiction, region, sector, industry, family, and/or individual. Some or all of the information may be anonymized and/or aggregated.

At block 410, entity proximity data structure management module 400 may receive an enrollment or sign-up request or sign-in by or from an entity. This block may involve processing of and/or assignment of authentication and authorization credentials of or to such party(ies). Entities may be assigned one or more entity 335 records in datastore 300.

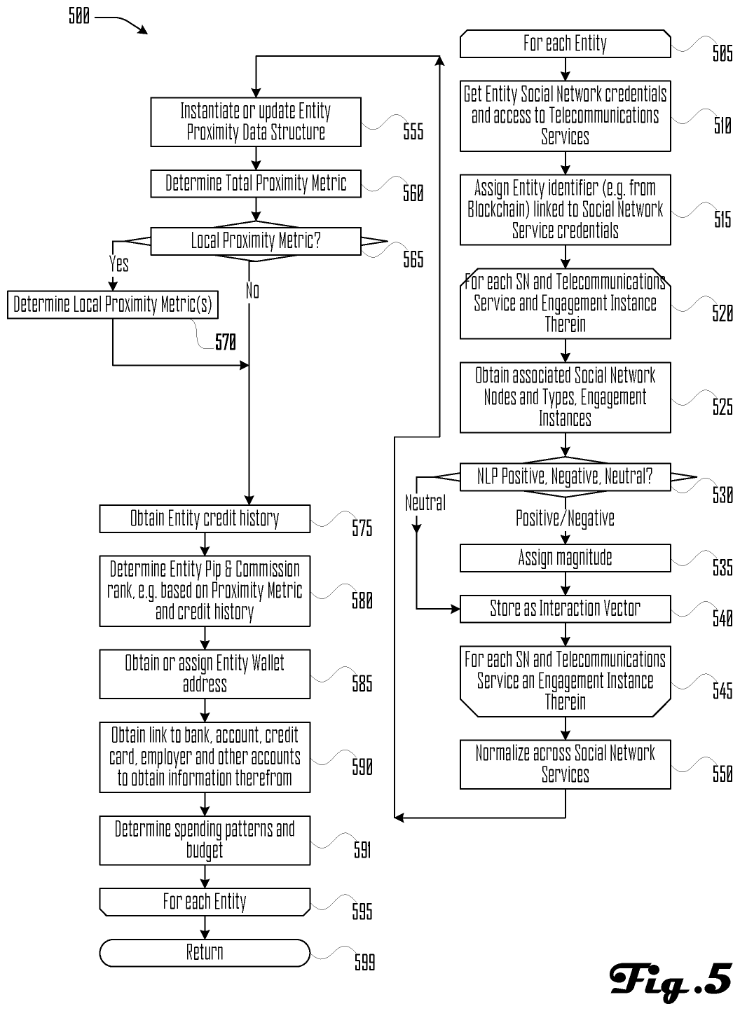

At block 500, entity proximity data structure management module 400 may perform entity proximity processing module 500, discussed further in relation to FIG. 5, to, for example, instantiate entity proximity data structure 310 and to determine local proximity metric 311 and total proximity metric 312 of or with respect to entities 335. Entity proximity processing module 500 may further obtain credit histories, determine pip and commission ratings or ranks, obtain, assign or otherwise manage blockchain wallet addresses, and obtain entity credentials for bank, account, credit card and other information sources.

Opening loop block 415 to closing loop block 445 may iterate over individual entities, such as those who signed up or signed in at block 410. Credentials may be evaluated, such as one or more credential 320 records. Opening loop block 415 to closing loop block 445 may also be referred to herein as “engagement assessment module”.

At decision block 420, entity proximity data structure management module 400 may determine whether an external loan is being submitted. An external loan is one which is not performed by the system. For example, a loan in which a bank is a creditor lending to a homeowner is likely to be an external loan, wherein the loan is performed by or under the direction of the bank. An internal loan is one which is performed by the system, such as a loan between members of debt assistant group 140, entity-1 110A, entity-2 1106, entity-3 and 110C (fine dotted lines in FIG. 1 represent transactions, such as lending, which may occur between elements, through communications which occur through network 150). Internal loans comprise loans performed with smart contracts on blockchain computer systems, under the direction of loan enrollment module 600.

At decision block 420, entity proximity data structure management module 400 may obtain a list or other data structure of loans and debtors with respect to the then-current entity. For example, the then-current entity may be a creditor who extends loans to debtors; such entity may desire for the loans and debtors of the then-current entity to be enrolled in the system. Such entity may provide a list or other data structure comprising loans and debtors which such entity desires to be enrolled in the system. Creditors and debtors may be assigned an identifier, such as one or more entity 335 records and/or one or more entity type 315 records. Entity type 315 records may identify a type of an entity. The type of an entity may be a generic type, such as individual or organization, or a type that is specific to a relationship or engagement instance with another entity, such as a creditor, debtor, employer, employee, contractor, or family relationship. Types may be obtained from social network services, from disclosure by third parties, from governmental sources, and the like. Loans may be assigned an identifier, which identifier may be store in datastore 300 as one or more loan 305 records.

Opening loop block 425 to closing loop block 430 may iterate over unenrolled debtors in the list of block 420.

At block 500, entity proximity data structure management module 400 may perform or execute entity proximity processing module 500 with respect to a then-current unenrolled debtor of the list of block 420. Entity proximity processing module 500 may be performed on a continuous basis, for all entities and associated entities which entity proximity processing module 500 encounters.

At closing loop block 430, entity proximity data structure management module 400 may return to opening loop block 425 to iterate over another unenrolled debtor. Upon occurrence of an interrupt condition, conclusion of unenrolled debtors, at an interval, or otherwise, entity proximity data structure management module 400 may proceed to opening loop block 435.

At decision block 421, entity proximity data structure management module 400 may determine whether an internal loan is to be processed. If affirmative, entity proximity data structure management module 400 may proceed to opening loop block 435. If negative, entity proximity data structure management module 400 may proceed to block 1000.

Opening loop block 435 to closing loop block 440 may iterate over each loan, such as with respect to loans and/or loan 305 records received or generated at block 410 or 420.

In engagement assessment module, entity proximity data structure management module 400 may perform one or more of loan enrollment module 600, loan execution module 700, debt assistant module 800, and debt collector module 900. These modules may provide services in relation to loans 305, including assessing whether to engage with a party, such as in a loan, monitoring loans, executing loans, soliciting parties to enter into loans, and the like, as discussed further herein.

At closing loop block 440, entity proximity data structure management module 400 may return to opening loop block 435 to iterate over another loan. Upon occurrence of an interrupt condition, conclusion of loans, at an interval, or otherwise, entity proximity data structure management module 400 may proceed to block 1000.

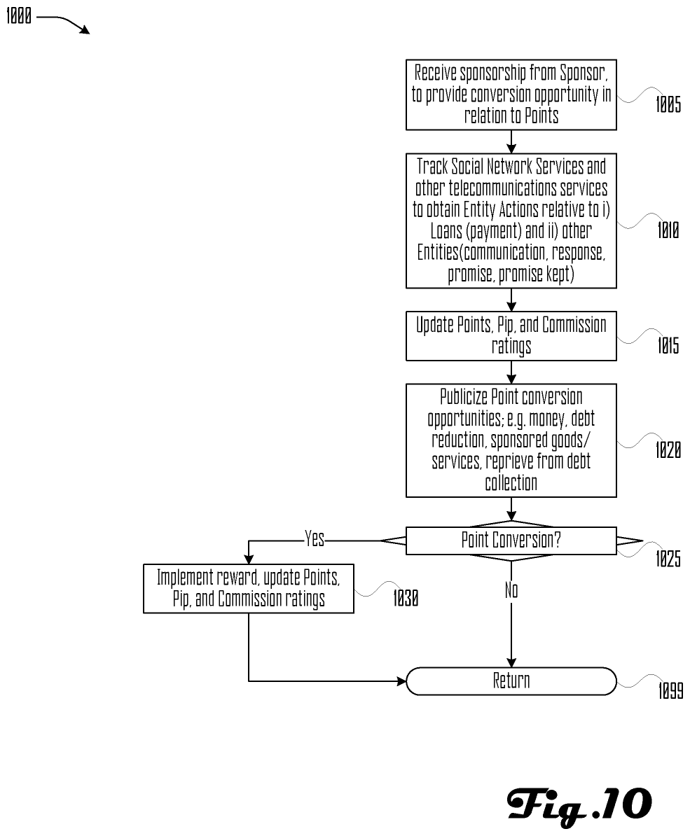

At block 1000, entity proximity data structure management module 400 may perform point management module 1000 to determine points earned by or to be awarded to a then-current entity. Point management module 1000 is discussed further in relation to FIG. 10.

At closing loop block 445, entity proximity data structure management module 400 may return to opening loop block 415 to iterate over another loan. Upon occurrence of an interrupt condition, conclusion of entities, at an interval, or otherwise, entity proximity data structure management module 400 may proceed to done or return block 499.

At done or return block 499, entity proximity data structure management module 400 may conclude or return to another process, such as one which may have called it.

FIG. 5 is a flow diagram illustrating an example of a method performed by an entity proximity processing module 500, according to some embodiments. Entity proximity processing module 500 may be performed by, for example, engagement management computer 200. Entity proximity processing module 500 may be called as a subroutine of another module or may be performed independently. A rate at which proximity processing module 500 is performed may be metered by, for example, a rate of communication by the monitored entity. For example, proximity processing module 500 may be performed more often with respect to an entity which communicates more than an entity which communicates less.

Opening loop block 505 to closing loop block 595 may iterate over entities, including entities who have enrolled in the system as well as entities, such as associated entities, which entity proximity processing module 500 encounters.

At block 510, entity proximity processing module 500 may obtain social network service credentials of or associated with a then-current entity. Social network service credentials my be stored in, for example, one or more credential 320 records. Entity proximity processing module 500 may further obtain access to telecommunications services of entity, as may be provided by, for example, telecommunications service 127. Such access may be provided by, for example, software installed in client telecommunications devices of entity or from credentials of the entity with the telecommunications service.

At block 515, entity proximity processing module 500 may assign an identifier to the entity, such as one or more entity 335 records. The identifier may be linked to, associated with, or derived from one or more records in a blockchain computer system. The entity 335 records may be linked to or associated with social network services of the entity.

Opening loop block 520 to closing loop block 545 may iterate over social network services and/or telecommunications services of block 510 and engagement instances therein.

At block 525, entity proximity processing module 500 may obtain entities or nodes associated with the then-current entity, e.g. associated entities. Associated entities may be entities who are “liked”, “friends” with, “followed by”, “following” or who are otherwise connected with or have communications with the then-current entity. Entity proximity processing module 500 may further assign or update one or more entity type 315 records to one or both of the then-current entity and the associated entity. The entity type 315 record may identify whether the then-current entity and/or the associated entity have a relationship as one or more of an employer, employee, familial relationship, creditor, debtor, or the like. The entity type may be determined, for example, from the social network service and/or from NLP.

At decision block 530, entity proximity processing module 500 may obtain engagement instances between the then-current entity and associated entities in the social network services and/or telecommunications services and may perform NLP on or with respect to the engagement instances to convert them into interaction vectors. As noted, NLP may be performed with or by hardware acceleration module 210. NLP may convert engagement instances into interaction vectors. For example, positive and negative words, “likes”, payments, and the like may be classified as positive, negative, or neutral. Multiple engagement instances and interaction vectors may be assigned to a given communication which may occur between entities.

At block 535, entity proximity processing module 500 may assign a magnitude to positive or negative engagement instances, or to neutral engagement instances, if the encoding system allows neutral to have a magnitude.

At block 540, entity proximity processing module 500 may store one or more interaction vectors as records, e.g. as interaction vector 313 record(s).

At closing loop block 545, entity proximity processing module 500 may return to opening loop block 520 to iterate over another social network or another telecommunications service of the then-current entity and an engagement instance therein. Upon occurrence of an interrupt condition, an interval, or conclusion of social network and telecommunications services of the then-current entity, entity proximity processing module 500 may proceed to block 550.

In embodiments, at block 550, entity proximity processing module 500 may normalize entities, entity types, and engagement instances across social network services. In embodiments, entity proximity processing module 500 may process separate social network services separately, with separate entity proximity data structures and with entities linked across social network services.

At block 555, entity proximity processing module 500 may instantiate or update an entity proximity data structure, such as entity proximity data structure 310, with the entity, engagement instances, and interaction vectors of preceding blocks. The entity proximity data structure may comprise entities, nodes, linked by engagement instances and/or interaction vectors representing engagement instances. The entity proximity data structure may hold nodes connected by algorithmic, logical, or mathematical relationships with positive, negative, and neutral values and magnitudes thereof.

At block 560, entity proximity processing module 500 may determine or update a total proximity metric, e.g. total proximity metric 312, for the then-current entity.

At decision block 565, entity proximity processing module 500 may determine or update whether one or more local proximity metric records, e.g. local proximity metric 311, are to be determined of or with respect to the then-current entity. Local proximity metric 311 records may be in relation to the entity and one or more associated entities, groups, or types, of associated entities and may be determined based on whether or not other processes require this information.

At block 575, entity proximity processing module 500 may obtain or update a credit history of the then-current entity.

At block 580, entity proximity processing module 500 may determine or update a pip and commission rank or rating of the then-current entity. This determination may be based on, for example, a proximity metric of the entity and/or the entity's credit history.

At block 585, entity proximity processing module 500 may obtain or assign a wallet address, such as an address on or in a blockchain computer system, to be used in relation to financial activities of the then-current entity with or managed by entity proximity data structure management module 400.

At block 590, entity proximity processing module 500 may obtain credentials for bank accounts, credit cards, other financial services of the then-current entity, employers, and the like and may obtain information therefrom. Certain of such information may constitute engagement instances.

At block 591, entity proximity processing module 500 may determine or obtain spending patterns and a budget of the then-current entity. This may be determined based on financial records and/or from input from the then-current entity.

At closing loop block 595, entity proximity processing module 500 may return to opening loop block 505 to iterate over another entity 335.

Upon occurrence of an interrupt condition or another exit condition or conclusion of iterations, at done or return block 599, entity proximity processing module 500 may conclude or return to another process, such as another process which may have called it.

In this way, entity proximity processing module 500 may instantiate and continuously update an entity proximity data structure. The entity proximity data structure comprises nodes comprising entities and associated entities. Associated entities are entities who have engagement instances between them. Entities and associated entities may be of an entity type with respect to other associated entities. The engagement instances are recorded in interaction vectors between associated entities. Proximity metrics may be determined for one of more of the entities. The proximity metrics may be a scalar product of interaction vectors between entities. The proximity metric may be a total proximity metric, encoding interaction vectors between a first entity and all associated entities of the first entity. The proximity metric may be a local proximity metric, encoding interaction vectors between the first entity and a subset all associated entities of the first entity.

The proximity metrics may be used to assess new engagement instances, such as new loans.

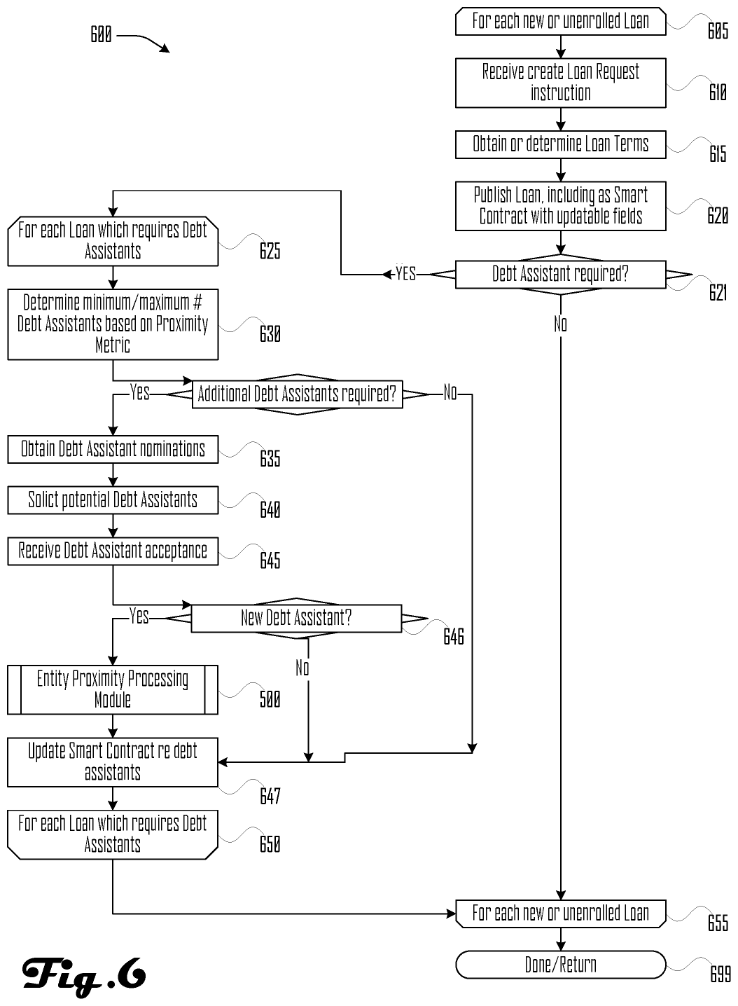

FIG. 6 is a flow diagram illustrating an example of a method performed by loan enrollment module 600, according to some embodiments. Loan enrollment module 600 may be performed by, for example, engagement management computer 200 or another computer, whether independently or as a subroutine, such as of entity proximity data structure management module 400.

Opening loop block 605 to closing loop block 655 may iterate over potential new engagements, such as new loans, including new loans to be created by loan enrollment module 600 and solicited to be funded, as well as over past engagements, such as unenrolled loans which a party wishes to enroll in loan enrollment module 600 such that the loan may be monitored or collected on through use of the system.

At block 610, loan enrollment module 600 may receive an instruction to create a loan or a potential loan in the system; as used herein, a potential loan is one wherein a principal amount of the loan has not been funded and disbursed to the debtor or another party. The loan may be assigned an identifier, such as one or more loan 305 records.

At block 615, loan enrollment module 600 may obtain or determine loan terms and other loan logic of loan 305 of block 610. The loan terms and logic may be recorded in one or more loan logic 355 records. With respect to loans to be enrolled in the system, the loan terms and loan logic may be obtained from a creditor or a debtor. With respect to loans to be created by loan enrollment module 600, the loan terms and loan logic may be created by, for example, loan enrollment module 600.

Loan terms and loan logic may comprise one or more of a principal amount of the loan, a creditor of the loan, a debtor of the loan, an interest rate, a maturity date or schedule of the loan, collateral which may secure the loan, pre-default progress stages of the loan, criteria according to which the loan will be characterized as an NPL, a commission to be paid with respect to collection of the loan or a record where a then-current commission may be obtained, and the like. The principal amount may be a request for principal with respect to a loan which has not yet been funded.

When creating a new loan to be performed or executed by, for example, loan execution module 700, loan enrollment module 600 may determine one or more of the foregoing loan terms and/or logic as follows:

An amount of loan principal of the loan may be input by an entity or by another module. In the case of loans among entities in a debt assistance group, such as entity-1 110A, entity-2 1106, and entity-3 110C in debt assistant group 140, loan principal may be provided by, for example, an entity, such as a debt assistant, or by debt assistant module 800, based on progress of the entity and prospective debtor regarding such party's ability to meet budgetary goals and progress goals with respect to upcoming loan obligations. For example, if an entity who is a member of a debt assistant group is not able to meet budgetary goals with respect to setting aside funds or not spending funds or not receiving receipts or other income, then debt assistant module 800 may assess or the entity may input that such entity may require a loan, including a loan with a principal amount.

Potential creditors with respect to a new loan may be open or may restricted to a type or class of entity. For example, potential creditors may be limited first to members of a debt assistant group, such as debt assistant group 140. If the loan request goes unfunded, after a period of time, potential creditors may be opened up to members of a social network group, such as social network group 141. This larger group may comprise “friends”, “contacts”, “followers”, and the like of the prospective debtor in social network services of the prospective debtor. If the loan request goes unfunded, after a period of time, potential creditors may be opened up to an open creditor group, such as open creditor group 142. This larger group may comprise institutional lenders and may comprise, for example, creditor 105.

Potential creditors with respect to a new loan may be restricted to an entity with a total proximity metric 312 or a local proximity metric 311, such as a local proximity metric 311 with respect to the prospective debtor, above or below a threshold. This threshold may be set by an entity, such as by the prospective debtor. This threshold may be set according to a desired interest rate with respect to the loan and with interest rate setting criteria, discussed as follows.

An interest rate of the loan may be set at least in part according to a prevailing market interest rate. An interest rate of the loan may be set at least in part by an entity, such as by the prospective debtor or by a prospective creditor. The interest rate may be set at least in part according to a ratio of a total proximity metric 312 of the prospective debtor relative to a total proximity metric 312 of the prospective creditor. For example, the interest rate may be more favorable to the creditor when the creditor's total proximity metric is higher than that of the debtor's total proximity metric. The interest rate may be set at least in part according to a local proximity metric of the prospective debtor. For example, when the local proximity metric of the prospective debtor goes down with respect to a debt assistant group or with respect to a creditor or group of creditors, then the interest rate may be increased.

Other loan terms may be set by entities and/or by other modules.

At block 620, loan enrollment module 600 may publish the loan. Publication of the loan may be to a blockchain computer system, for example, as records on the blockchain computer system and/or as a smart contract to be executed by the blockchain computer system. Publication of the loan may be with records, values, or parameters which may be updated over time, such as records which call a proximity metric, wherein the proximity metric changes over time, or such as records for a commission to be paid, an allowed collector identifier, an allowed payor identifier, for re-assignment of creditor rights, and the like.

Publication of the loan may be with records cryptographically secured, such that information regarding the loan may only be obtained or changed by authorized parties or events. Even where cryptographically secured, anonymized and/or aggregated information may be revealed, so as to improve transparency with respect to credit utilization.

At decision block 621, loan enrollment module 600 may determine whether debt assistants or participation of the debtor in a debt assistant group are required as a condition of the loan.

When affirmative or equivalent at decision block 621, opening loop block 625 to closing loop block 650 may iterate over loans which require participation by the debtor in a debt assistant group. For example, creditors, who may also be members of a debt assistant group or who may be general creditors, may require that debtors be part of a debt assistant group in order to qualify for a loan.

At block 630, loan enrollment module 600 may obtain or determine a minimum or maximum number of debt assistants who may be required in relation to a loan. This number may be set by an entity and/or may be determined, for example, based on a proximity metric of the debtor. The proximity metric of the debtor may be a total proximity metric of the debtor or may be a local proximity metric of the debtor relative to other entities, such as members of a debt assistant group.

At block 635, if a sufficient number of debt assistants are not already in a debt assistant group with the prospective debtor or simply because the debtor would like to nominate additional debt assistants, loan enrollment module 600 may obtain nominations for parties to be debt assistants.

At block 640, loan enrollment module 600 may solicit the parties to become debt assistants.

At block 645, loan enrollment module 600 may receive one or more acceptances by the solicited debt assistants to become debt assistants.

At decision block 646, loan enrollment module 600 may determine whether a debt assistant is new to the system.

If affirmative or equivalent at block 646, for new debt assistants, loan enrollment module 600 may call entity proximity processing module 500, to enroll such new debt assistants as entities with accounts in the system, with entries in the entity proximity data structure, and the like.

At block 647, loan enrollment module 600 may update a smart contract regarding the debt assistants of preceding blocks.

At closing loop block 650, loan enrollment module 600 may return to opening loop block 625 to iterate over a next loan which requires debt assistants.

At closing loop block 655, loan enrollment module 600 may return to opening loop block 605 to iterate over a new or unenrolled loan.

Upon occurrence of an interrupt condition or another exit condition or conclusion of iterations, at done or return block 699, loan enrollment module 600 may conclude or return to another process, such as another process which may have called it.

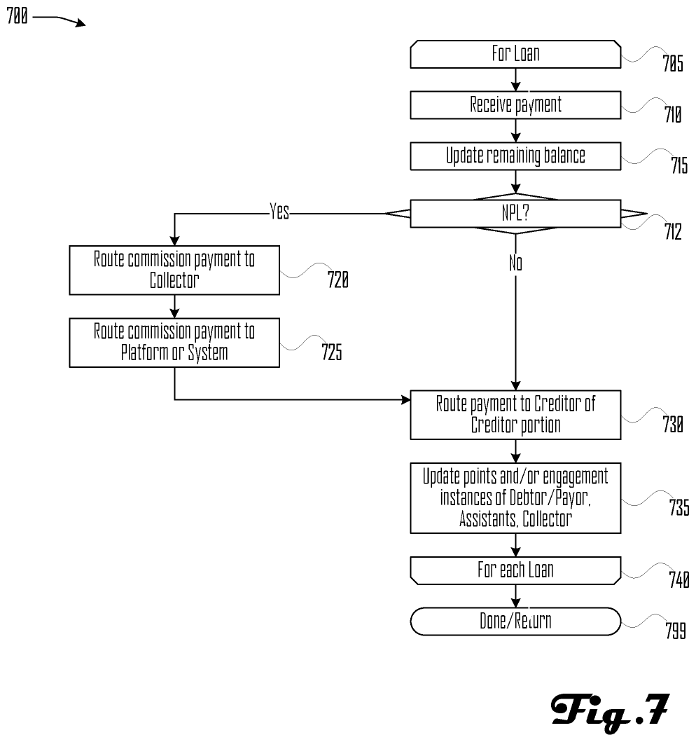

FIG. 7 is a flow diagram illustrating an example of a method performed by a loan execution module 700, according to some embodiments. Loan execution module 700 may be performed by, for example, engagement management computer 200 and/or by one or more a smart contracts or logic published to and performed by a blockchain computer system. Loan execution module 700 may be called as a subroutine of another module, such as by entity proximity data structure management module 400 or may be performed independently.

Opening loop block 705 to closing loop block 740 may iterate over loans monitored or executed by loan execution module 700.

At block 710, loan execution module 700 may receive a payment toward an outstanding loan balance. For example, the payment may have been sent to a loan payment address 397 of the loan.

At block 715, loan execution module 700 may update a remaining balance of the loan.

At decision block 712, loan execution module 700 may determine whether the then-current loan is an NPL.

If affirmative or equivalent at decision block 712, at block 720, loan execution module 700 may route a commission payment to a party who acts as a debt collector with respect to the loan. For example, if the loan has become an NPL, then debt collectors may receive commissions for payments attributable to them.

At block 725, loan execution module 700 may route a commission payment to the system.

At block 730, loan execution module 700 may route a payment to the creditor of the loan.

At block 735, loan execution module 700 may update points and/or engagement instances of one or more of the debtor, a payor, a debt assistant, or a debt collector.

At closing loop block 740, loan execution module 700 may return to opening loop block 705 to iterate over the next loan.

Upon occurrence of an interrupt condition or another exit condition or conclusion of iterations, at done or return block 799, loan execution module 700 may conclude or return to another process, such as another process which may have called it.

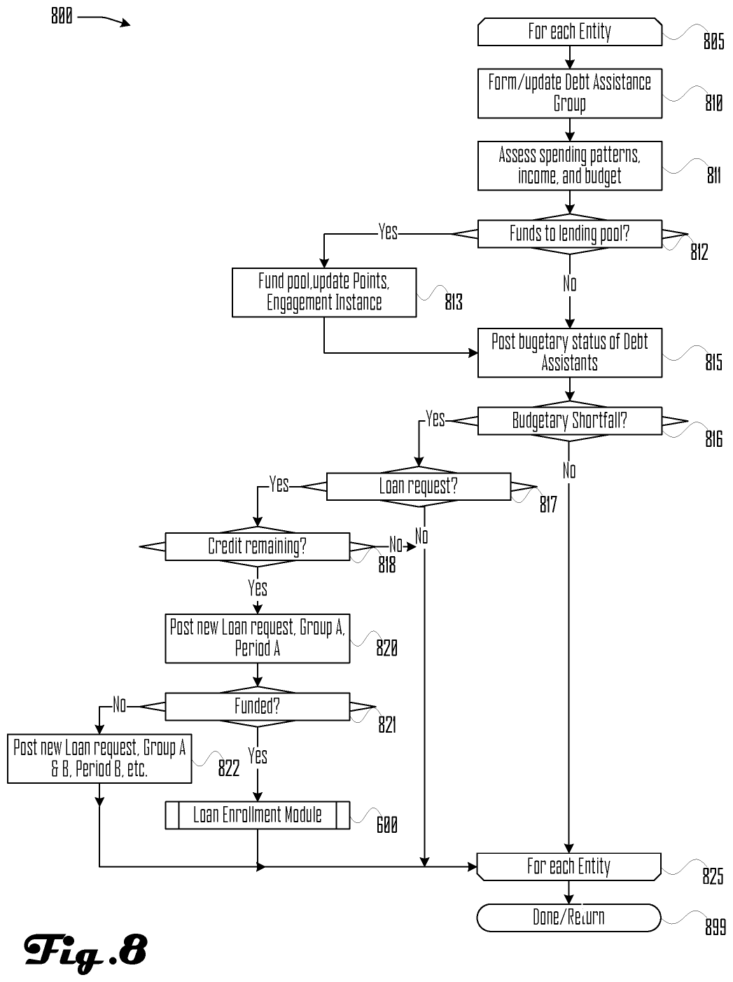

FIG. 8 is a flow diagram illustrating an example of a method performed by a debt assistant module 800, according to some embodiments. Debt assistant module 800 may be performed by, for example, engagement management computer 200 or another computer, whether independently or as a subroutine, such as of entity proximity data structure management module 400.

Opening loop block 805 through closing loop block 825 may iterate over entities, such as entities of entity proximity data structure management module 400.

At block 810, debt assistant module 800 may form or update a debt assistant group. Members of the debt assistant group may be selected by entities. Members of the debt assistant group may join the debt assistant group, such as in response to an invitation or at their own initiative.

At block 811, debt assistant module 800 may assess spending patterns, income, and budget of the then-current entity. Information for this may come from, for example, the entity and/or from, for example, entity proximity processing module 500.

At decision block 812, debt assistant module 800 may determine whether the then-current entity has funds and willingness to contribute to a lending pool of the debt assistant group. The then-current entity may earn points and positive engagement instances for contributing or making available funds to the lending pool.

If affirmative or equivalent at decision block 812, at block 813 debt assistant module 800 may update points and engagement instances for the then-current entity and debt assistant and may fund the lending pool or otherwise note that funds of the then-current entity are available to be used as part of the lending pool.

At block 815, debt assistant module 800 may post a budgetary status of the then-current entity and debt assistant to the debt assistant group(s) of such entity. The budgetary status may comprise spending patterns, budgetary objectives, income, loan obligations, and the like. The loan obligations may comprise debt assistant loans. Debt assistant loans may be loans between members of the debt assistant group and/or loans entered into by members of the debt assistant group, which loans the members want to receive support in relation thereto. The status may comprise, for example, loan principal amounts, upcoming due amounts, interest rates, and the like. Other members of the debt assistant group may then be aware of the budgetary status and credit utilization by other members of the debt assistant group, including how obligations among the members are being settled.

At decision block 816, debt assistant module 800 may determine whether the then-current entity is likely to experience a near-term budgetary shortfall.

If affirmative or equivalent at decision block 816, at decision block 817, debt assistant module 800 may determine whether a loan request is to be generated with respect to some or all of the budgetary shortfall.

If affirmative or equivalent at decision block 817, at decision block 818, debt assistant module 800 may determine whether the then-current entity has credit remaining which may be used to obtain a loan.

If affirmative or equivalent at decision block 818, at block 820, debt assistant module 800 may post new loan requests to a first group for a first period of time. For example, the first group may be the debt assistant group. For example, the first period of time may be a short period, on the order of hours to days, or it may be until an event, such as when prospective creditors in the first group decline to loan to the then-current entity. The new loan requests may be generated by loan enrollment module 600. The new loan requests may be in relation to upcoming budgetary shortfall and/or loan obligations which a debt assistant is not going to be able to meet.

At decision block 821, debt assistant module 800 may determine whether the loan request of block 820 has been funded. Funding of the loan request may be determined by debt assistant module 800 when, for example, the lending pool has available funds, such as from another member of the debt assistant group of the then-current entity.

If negative or equivalent at decision block 821, at block 822, debt assistant module 800 may post the new loan requests to a second group for a second period of time. For example, the second group may be a larger group comprising social network service connections of the then-current entity, such as social network group 141, including such connections who may have expressed a willingness to become a creditor. For example, the second period of time may be a short period, on the order of hours to days, or it may be until an event, such as when prospective creditors in the second group decline to loan to the then-current entity.

If the new loan request of block 822 is not funded, blocks equivalent to 821 and 822 may iterate with, for example, successively larger groups of potential creditors, such as, for example, with or to open creditor group 142.

At block 600, debt assistant module 800 may call or perform loan enrollment module 600 to enroll the funded new loan.

At closing loop block 825, debt assistant module 800 may return to opening loop block 805, to iterate over another entity and debt assistant group(s) of such other entity.

Upon occurrence of an interrupt condition or another exit condition or conclusion of iterations, at done or return block 899, debt assistant module 800 may conclude or return to another process, such as another process which may have called it.

As processed by point management module 1000, if a first debt assistant helps a second debt assistant meet a budgetary shortfall or loan obligation, the first debt assistant may earn points, in addition to earning interest. As processed by entity proximity processing module 500, the debt assistants may also improve their local proximity metrics with respect to one another and their total proximity metric, through interaction with one another. In this way, debt assistant groups may help their members manage their credit utilization and improve their ability to obtain and responsibly use credit.

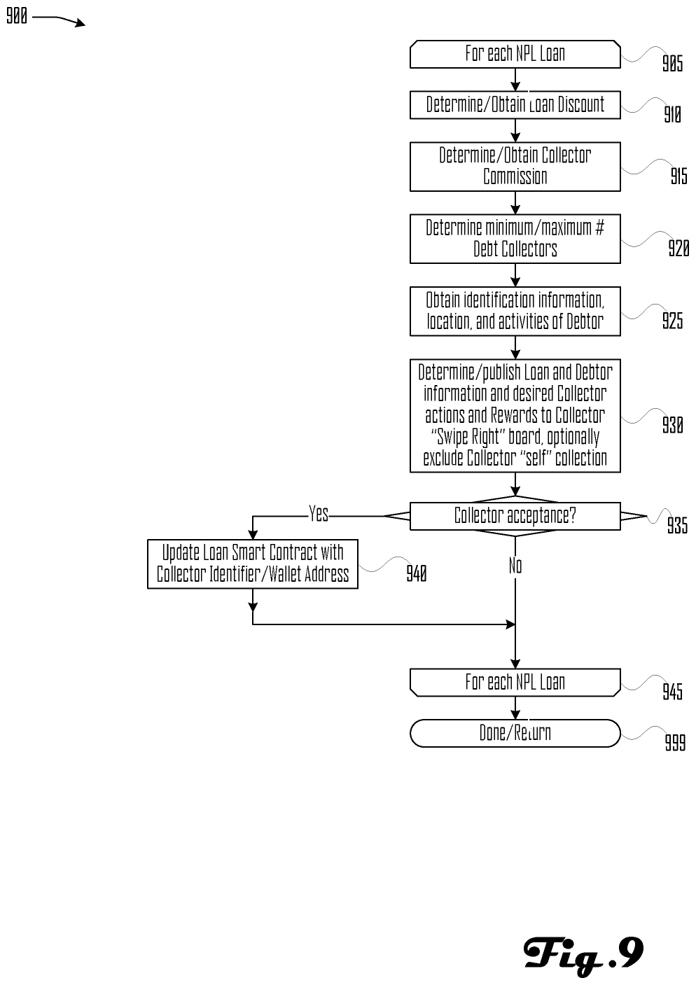

FIG. 9 is a flow diagram illustrating an example of a method performed by a debt collector module 900, according to some embodiments.

Opening loop block 905 to closing loop block 945 may iterate over loans with an NPL status.

At block 910, debt collector module 900 may determine or obtain a loan discount relative to the NPL.

At block 915, debt collector module 900 may determine or obtain a commission to be paid to or earned by a debt collector.

At block 920, debt collector module 900 may determine or obtain a minimum or maximum number of debt collectors who may be activated relative to the NPL.

At block 925, debt collector module 900 may obtain identification information, location and activities of the debtor of the NPL.

At block 930, debt collector module 900 may determine and publish information regarding the NPL and debtor, desired collection actions, and rewards to be earned for collection actions to a “swipe right” board. The “swipe right” board may be an app or similar which publishes this information and allows prospective debt collectors to review NPL, commissions, and the like and select NPL that the debt collector would like to take action on or with respect to. In an embodiment, the debt collector may be excluded from seeing the debt collector's own NPL.

At decision block 935, debt collector module 900 may determine whether a debt collector has accepted debt collection with respect to a then-current NLP loan.

If affirmative or equivalent at decision block 935, such as following receipt of a debt collector's acceptance of to engage in collection activities with an NPL, at block 940, debt collector module 900 may update a smart contract or other computer system with the debt collector's identifier and/or wallet address, which may be specific to this NPL. When the debt collector engages in collection activities, the debt collector may direct that payments are to go through the wallet address and/or a link and/or use another technology to allow the payment to go toward satisfaction of the debt, while the debt collector is credited with the payment, according to loan execution module 700.

At closing loop block 945, debt collector module 900 may return to opening loop block 905, to iterate over another NPL loan.

FIG. 10 is a flow diagram illustrating an example of a method performed by a point management module 1000, according to some embodiments. Point management module 1000 may be performed by, for example, engagement management computer 200 or another computer, whether independently or as a subroutine, such as of entity proximity data structure management module 400.

At block 1005, point management module 1000 may receive a sponsorship from a sponsor. The sponsorship may allow points earned in the system to be converted into rewards provided by the sponsor.

At block 1010, point management module 1000 may track social network services and other telecommunication services for engagement instances which are eligible to earn points in addition to effecting a proximity metric. For example, points may be earned for particular engagement instances, such as payment toward a loan, or positive interaction vectors with associated entities, such as associated entities of a type, such as creditors, debt assistants, debt collectors.

At block 1015, point management module 1000 may update points, pip, and commission ratings of parties who earned points.

At block 1020, point management module 1000 may publicize point conversion opportunities. E.g. ability to convert points into money, into debt reduction, into sponsored goods/services, reprieve from debt collection for a period, or the like.

At decision block 1025, point management module 1000 may determine whether one or more points are to be converted into rewards, such as receipt of a point conversion from an entity.

If affirmative or equivalent at decision block 1025, at block 1030, point management module 1000 may implement the reward and may update points, pip, and commission ratings.

The above noted flow diagrams illustrate examples of arrangement of logic; other logic and other arrangements of the logic or equivalent logic may be practiced.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions. USB (Universal serial bus) may comply or be compatible with Universal Serial Bus Specification, Revision 2.0, published by the Universal Serial Bus organization, Apr. 27, 2000, and/or later versions of this specification, for example, Universal Serial Bus Specification, Revision 3.1, published Jul. 26, 2013. PCIe may comply or be compatible with PCI Express 3.0 Base specification, Revision 3.0, published by Peripheral Component Interconnect Special Interest Group (PCI-SIG), November 2010, and/or later and/or related versions of this specification.

As used herein, “social network service” is an online platform used by humans and organization to build social networks or social relations among humans and organizations who share similar personal or career interests, activities, backgrounds or real-life connections. Examples of social network services include Facebook, YouTube, Instagram, Sina Weubo, WeChat, Naver, Line, Ozone, and the like.

As used herein, “telecommunications service” is a communication service which provides voice, text, and data services.

As used herein, a “blockchain computer system” is a decentralized, distributed, public, quasi-public, or private computer system in which blockchain nodes cryptographically hash successive blocks of data to a blockchain datastore according to a time-stamping technique; time-stamping techniques include, for example, proof-of-stake and proof-of-work. Blockchain computer systems are governed by blockchain rules. Blockchain rules generally require consensus of greater than a threshold of then-current blockchain nodes (typically a more than half) to add new blocks to the blockchain; correspondingly, blockchain rules generally prevent changes to the entire set of records in a blockchain, including past records, without consensus. Blockchain rules are generally permissionless for public blockchains, which means that records and/or applications can be added to the blockchain datastore applications without access control and without the approval or trust of others, using the blockchain rules as a transport layer. Processing and storage of records in the blockchain datastore according to the blockchain rules is performed by one or more blockchain nodes. Examples of blockchain computer systems include the Bitcoin network, the Ethereum network, and the like.

As used herein, a “blockchain datastore” is a series of blocks of data, wherein each subsequent block in the series includes a cryptographic hash of one or more preceding blocks in the series. A blockchain datastore is the current state of a blockchain computer system. The blocks of data generally comprise a hash of a previous block of data, a timestamp, and a transaction data. A blockchain datastore may be represented as a Merkle tree.

As used herein, a “blockchain node” is a computer which follows blockchain rules of a blockchain computer system. Blockchain nodes i) write or have written one or more blocks of data to a blockchain datastore and/or ii) access and report the contents of a blockchain datastore. Blockchain nodes may execute a blockchain virtual machine to access and process records in the blockchain datastore.

As used herein, a “smart contract” is a software routine, process, or logic for a module in a blockchain computer system. Smart contracts are written to a datastore of a blockchain computer system and are executed by blockchain nodes.

As used herein, “jurisdiction” refers to a government and a corresponding geographic region.

As used in any embodiment herein, the term “logic” may refer to the logic of the instructions of an app, software, and/or firmware, and/or the logic embodied into a programmable circuitry by a configuration bit stream, to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as FPGA. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

As used herein, the term “module” (or “logic”) may refer to, be part of, or include an Application Specific Integrated Circuit (ASIC), a System on a Chip (SoC), an electronic circuit, a programmed programmable circuit (such as, Field Programmable Gate Array (FPGA)), a processor (shared, dedicated, or group) and/or memory (shared, dedicated, or group) or in another computer hardware component or device that execute one or more software or firmware programs having executable machine instructions (generated from an assembler and/or a compiler) or a combination, a combinational logic circuit, and/or other suitable components with logic that provide the described functionality. Modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures.

As used herein, a process corresponds to an instance of a program, e.g., an application program, executing on a processor and a thread corresponds to a portion of the process. A processor may include one or more execution core(s). The processor may be configured as one or more socket(s) that may each include one or more execution core(s).

### EXAMPLES

Following are non-exclusive examples.

### Example 1

An apparatus, system, method, or means for proximity engagement level assessment, comprising: a computer processor and a memory; an entity proximity processing module in the memory, the processor operative to execute the entity proximity processing module, wherein the entity proximity processing module is to instantiate an entity proximity data structure, wherein the entity proximity data structure comprises a plurality of associated entities and a proximity metric for each entity in the plurality of associated entities; and an engagement assessment module operative to assess a new engagement instance with a first entity in the plurality of associated entities based at least in part on a first entity proximity metric of the first entity in the entity proximity data structure.

### Example 2

The apparatus, system, method or means for proximity level assessment according to example 1 or another example herein, wherein the proximity metric for each entity in the plurality of associated entities comprises a total proximity metric comprising a scalar product of interaction vectors between each such entity and associated entities in the plurality of associated entities.

### Example 3

The apparatus, system, method or means for proximity level assessment according to example 2 or another example herein, wherein the proximity metric for each entity in the plurality of associated entities comprises a local proximity metric comprising a scalar product of interaction vectors between each such entity and a subset of associated entities of such entities in the plurality of associated entities.

### Example 4

The apparatus, system, method or means for proximity level assessment according to example 1 or another example herein, wherein the plurality of associated entities comprises the apparatus for proximity engagement assessment, organizations, and individuals.

### Example 5

The apparatus, system, method or means for proximity level assessment according to example 2, example 3, or another example herein, wherein interaction vectors comprise engagement instances between entities in the plurality of associated entities.

### Example 6

The apparatus, system, method or means for proximity level assessment according to example 5 or another example herein, wherein engagement instances may be positive, negative, or neutral engagement instances.

### Example 7

The apparatus, system, method or means for proximity level assessment according to example 5 or another example herein, wherein the engagement instances comprise at least one of a verbal or written communication, a presence at a common physical location, a membership in an organization, a promise to act, or an action to fulfill the promise to act, and wherein the engagement instances are derived from at least one of a social network service, a telecommunications service, a lending service, or location data.

### Example 8

The apparatus, system, method or means for proximity level assessment according to example 7 or another example herein, wherein the promise to act is a promise to repay a loan and the action to fulfill the promise to act is repayment of or toward the loan.

### Example 9

The apparatus, system, method or means for proximity level assessment according to example 8 or another example herein, wherein the loan is originated by at least one of the apparatus for proximity engagement level assessment or a party that is not the apparatus for proximity engagement level assessment.

### Example 10

The apparatus, system, method or means for proximity level assessment according to example 1 or another example herein, wherein entities may have entity type relationships with one another, wherein the entity type relationships comprise at least one of a work relationship, a social relationship, or a familial relationship.

### Example 11

The apparatus, system, method or means for proximity level assessment according to example 5 or another example herein, wherein the entity proximity processing module is to assign a point to the first entity for an engagement instance by the first entity.

### Example 12

The apparatus, system, method or means for proximity level assessment according to example 11 or another example herein, wherein the engagement instance comprises at least one of a payment toward a loan obligation, a communication with the entity proximity processing module, an entry into or an interaction with a debt assistant group, a communication with another entity in relation to a loan, or another action with respect to a loan or with respect to another entity.

### Example 13

The apparatus, system, method or means for proximity level assessment according to example 11 or another example herein, wherein the point is convertible into a reward.

### Example 14

The apparatus, system, method or means for proximity level assessment according to example 13 or another example herein, wherein the reward comprises at least one of cash, cryptocurrency, goods or services, debt relief, or non-disclosure of information.

### Example 15

The apparatus, system, method or means for proximity level assessment according to example 1 or another example herein, wherein the engagement assessment module is operative to instantiate the new engagement instance with the first entity in a smart contract comprising terms, wherein the terms are varied based at least in part on the first entity proximity metric.

### Example 16

The apparatus, system, method or means for proximity level assessment according to example 15 or another example herein, wherein the terms comprise at least one of a creditor, a number of debt assistants of the first entity, a principal amount of a loan, an interest rate of the loan, a maturity date of the loan, a debt collector, a commission paid for collection activities directed to the loan, or a discount for sale of the loan.

### Example 17

The apparatus, system, method or means for proximity level assessment according to example 16 or another example herein, wherein an amount of the commission paid for collection activities directed to the loan is determined according to a payment history, a number of debt assistants, a credit history of the first entity, a number of debt collectors, or, when the loan is to the first entity, a ratio of the proximity metric of the first entity and a proximity metric of a second entity.

### Example 18

The apparatus, system, method or means for proximity level assessment according to example 16 or another example herein, wherein the commission paid for collection activities directed to the loan increases if repayment occurs in a shorter period of time and decreases if repayment occurs in a longer period of time.

### Example 19

The apparatus, system, method or means for proximity level assessment according to example 16 or another example herein, wherein the debt collector is associated with an address, account, or link which associates a payment received by such address, account, or link with the debt collector.

### Example 20

The apparatus, system, method or means for proximity level assessment according to example 16 or another example herein, wherein the first entity is a first member of a debt assistant group and the creditor comprises a second member of the debt assistant group.

### Example 21

The apparatus, system, method or means for proximity level assessment according to example 20 or another example herein, wherein the creditor is a second entity in the entity proximity data structure and the variable terms are varied based at least in part on the first entity proximity metric relative to a second entity proximity metric of the second entity in the entity proximity data structure.

### Example 22

The apparatus, system, method or means for proximity level assessment according to example 21 or another example herein, wherein the interest rate of the loan is more favorable for the first entity when the first entity proximity metric is greater than the second entity proximity metric.

### Example 23

The apparatus, system, method or means for proximity level assessment according to example 8 or another example herein, wherein repayment of the new engagement instance according to its terms is a positive engagement instance.

### Example 24

The apparatus, system, method or means for proximity level assessment according to example 15 or another example herein, wherein the engagement assessment module is operative to instantiate the new engagement instance when the first entity experiences a budgetary shortfall.

### Example 25

The apparatus, system, method or means for proximity level assessment according to example 15 or another example herein, wherein the engagement assessment module is operative to offer the new engagement instance first to members of a debt assistant group and, if not accepted there, then from associated entities of the first entity in a social network service of the first entity and, if not accepted there, then from an open lending group.

### Example 26

The apparatus, system, method or means for proximity level assessment according to example 1 or another example herein, wherein a creditor enrolls a non-performing loan (“NPL”) of the first entity with the apparatus for proximity engagement level assessment.

### Example 27

The apparatus, system, method or means for proximity level assessment according to example 26 or another example herein, wherein the enrolled NPL is made available for collection by debt collectors.

### Example 28

The apparatus, system, method or means for proximity level assessment according to example 27 or another example herein, wherein the debt collectors are provided with information regarding the first entity, wherein the information comprises at least one of a location of the first entity, a contact information of the first entity, a debt assistant of the first entity, an income stream of the first entity, and an obligation or loan of the first entity.

1. An apparatus for proximity engagement level assessment, comprising: a computer processor and a memory; an entity proximity processing module in the memory, the processor operative to execute the entity proximity processing module, wherein the entity proximity processing module is to instantiate an entity proximity data structure, wherein the entity proximity data structure comprises a plurality of associated entities and a proximity metric for each entity in the plurality of associated entities; and an engagement assessment module operative to assess a new engagement instance with a first entity in the plurality of associated entities based at least in part on a first entity proximity metric of the first entity in the entity proximity data structure.

2. The apparatus according to claim 1, wherein the proximity metric for each entity in the plurality of associated entities comprises at least one of a total proximity metric comprising a scalar product of interaction vectors between each such entity and associated entities in the plurality of associated entities and a local proximity metric comprising a scalar product of interaction vectors between each such entity and a subset of associated entities of such entities in the plurality of associated entities.

3. The apparatus according to claim 2, wherein interaction vectors comprise engagement instances between entities in the plurality of associated entities.

4. The apparatus according to claim 3, wherein engagement instances comprise at least one of a verbal or written communication, a presence at a common physical location, a membership in a debt assistant group, a promise to act, or an action to fulfill the promise to act, and wherein the engagement instances are derived by natural language processing (“NLP”) from at least one of a social network service, a telecommunications service, a lending service, or location data and wherein the NLP determines the interaction vectors to be positive, negative, neutral vectors with a magnitude.

5. The apparatus according to claim 3, wherein the entity proximity processing module is to assign a point to the first entity for an engagement instance by the first entity, wherein the point is convertible into a reward and wherein the reward comprises at least one of cash, cryptocurrency, goods or services, debt relief, or non-disclosure of information.

6. The apparatus according to claim 1, wherein the engagement assessment module is operative to instantiate the new engagement instance with the first entity as a loan in a smart contract comprising variable terms, wherein the variable terms comprise at least interest, wherein the variable terms are varied based at least in part on the first entity proximity metric, wherein the smart contract comprises logic executed by a blockchain computer system, wherein the first entity is a first member of a debt assistant group and the creditor is a second member of the debt assistant group and wherein the creditor is a second entity in the entity proximity data structure and the variable terms are varied based at least in part on the first entity proximity metric relative to a second entity proximity metric of the second entity in the entity proximity data structure.

7. The apparatus according to claim 6, wherein the variable terms further comprise a commission paid for collection activities directed to the loan and wherein the commission paid for collection activities directed to the loan is determined according to a payment history, a number of debt assistants, a credit history of the first entity, a number of debt collectors, and wherein the commission paid for collection activities directed to the loan increases if repayment occurs in a shorter period of time and decreases if repayment occurs in a longer period of time.

8. A method for proximity engagement level assessment, the method performed by a computer processor and a memory, the method comprising instantiating an entity proximity data structure, wherein the entity proximity data structure comprises a plurality of associated entities and a proximity metric for each entity in the plurality of associated entities; and assessing a new engagement instance with a first entity in the plurality of associated entities based at least in part on a first entity proximity metric of the first entity in the entity proximity data structure.

9. The method according to claim 8, wherein the proximity metric for each entity in the plurality of associated entities comprises at least one of a total proximity metric or a local proximity metric and determining the total proximity metric according to a scalar product of interaction vectors between each such entity and associated entities in the plurality of associated entities and determining the local proximity metric according to a scalar product of interaction vectors between each such entity and a subset of associated entities of such entities in the plurality of associated entities.

10. The method according to claim 9, further comprising determining the interaction vectors based on natural language processing (“NLP”) of engagement instances between entities in the plurality of associated entities.

11. The method according to claim 10, further comprising performing the NLP on engagement instances in communications from at least one of a social network service, a telecommunications service, a lending service and wherein the NLP determines the interaction vectors to be positive, negative, neutral vectors with a magnitude.

12. The method according to claim 10, further comprising assigning a point to the first entity for an engagement instance by the first entity, wherein the point is convertible into a reward and wherein the reward comprises at least one of cash, cryptocurrency, goods or services, debt relief, or non-disclosure of information.

13. The method according to claim 8, further comprising instantiating the new engagement instance with the first entity as a loan in a smart contract comprising variable terms, wherein the variable terms comprise at least interest, wherein the variable terms are varied based at least in part on the first entity proximity metric, wherein the smart contract comprises logic executed by a blockchain computer system, wherein the first entity is a first member of a debt assistant group and the creditor is a second member of the debt assistant group and wherein the creditor is a second entity in the entity proximity data structure and further comprising varying the variable terms based at least in part on the first entity proximity metric relative to a second entity proximity metric of the second entity in the entity proximity data structure.

14. The method according to claim 13, wherein the variable terms further comprise a commission paid for collection activities directed to the loan and determining the commission paid for collection activities directed to the loan based on a payment history, a number of debt assistants, a credit history of the first entity, a number of debt collectors, and wherein the commission paid for collection activities directed to the loan increases if repayment occurs in a shorter period of time and decreases if repayment occurs in a longer period of time.

15. One or more computer-readable media comprising instructions that cause a computer device, in response to execution of the instructions by a processor of the computer device, to instantiate an entity proximity data structure, wherein the entity proximity data structure comprises a plurality of associated entities and a proximity metric for each entity in the plurality of associated entities; and assess a new engagement instance with a first entity in the plurality of associated entities based at least in part on a first entity proximity metric of the first entity in the entity proximity data structure.

16. The computer-readable media according to claim 15, wherein the proximity metric for each entity in the plurality of associated entities comprises at least one of a total proximity metric or a local proximity metric and the instructions further cause the computer device to determine the total proximity metric according to a scalar product of interaction vectors between each such entity and associated entities in the plurality of associated entities and determine the local proximity metric according to a scalar product of interaction vectors between each such entity and a subset of associated entities of such entities in the plurality of associated entities.

17. The computer-readable media according to claim 16, wherein the instructions further cause the computer device to perform natural language processing (“NLP”) on engagement instances between entities in the plurality of associated entities and to determine the interaction vectors based on such NLP.

18. The computer-readable media according to claim 17, wherein the instructions further cause the computer device to perform the NLP on engagement instances in communications from at least one of a social network service, a telecommunications service, a lending service and wherein the instructions further cause the computer device to perform the NLP to determine the interaction vectors to be positive, negative, neutral vectors with a magnitude.

19. The computer-readable media according to claim 17, wherein the instructions further cause the computer device to assign a point to the first entity for an engagement instance by the first entity, wherein the point is convertible into a reward and wherein the reward comprises at least one of cash, cryptocurrency, goods or services, debt relief, or non-disclosure of information.

20. The computer-readable media according to claim 15, wherein the instructions further cause the computer device to instantiate the new engagement instance with the first entity as a loan in a smart contract comprising variable terms, wherein the variable terms comprise at least interest, wherein the instructions further cause the computer device to vary the the variable terms based at least in part on the first entity proximity metric, wherein the smart contract comprises logic executed by a blockchain computer system, wherein the first entity is a first member of a debt assistant group and the creditor is a second member of the debt assistant group and wherein the creditor is a second entity in the entity proximity data structure and wherein the instructions further cause the computer to vary the variable terms based at least in part on the first entity proximity metric relative to a second entity proximity metric of the second entity in the entity proximity data structure.
